(19) United States
(12) Patent Application Publication
(10) Pub. No.: US 2026/0265136 A1
(43) Pub. Date: Sep. 10, 2026

(54) METHOD FOR FULLY UTILIZING OLD MORTAR ON SURFACES OF RECYCLED COARSE AGGREGATES

(71) Applicant: WUHAN UNIVERSITY, Wuhan City (CN)

(72) Inventors: Zhenzhen Liu, Wuhan City (CN); Yiyan Lu, Wuhan City (CN); Shan Li, Wuhan City, (CN); Zhifeng Guo, Wuhan City, (CN); Yue Huang, Wuhan City (CN)

(21) Appl. No.: 19/360,321

(22) Filed: Oct. 16, 2025

(30) Foreign Application Priority Data
Mar. 10, 2025 (CN) 202510273621.5

(51) Int. Cl. C04B 18/167; C04B 18/08; C04B 20/10; C04B 20/12

(52) U.S. Cl. CPC C04B 18/167; C04B 18/08; C04B 20/1037; C04B 20/12; C04B 2201/50

(57) ABSTRACT

A method for fully utilizing old mortar on surfaces of recycled coarse aggregates is provided. The method includes the following steps: S1, performing a weakening treatment on recycled coarse aggregates to obtain pre-treated recycled coarse aggregates, where an elastic modulus of old mortar on surfaces of the pre-treated recycled coarse aggregates is 15% to 80% of an elastic modulus of old mortar on surfaces of original recycled coarse aggregates; S2, reacting an isocyanate component and an amino compound in solvent oil to obtain a polyurea coating material, then spraying the polyurea coating material onto surfaces of the pre-treated recycled coarse aggregates to obtain modified recycled coarse aggregates; and S3, preparing recycled concrete using the modified recycled coarse aggregates obtained in the step S2.

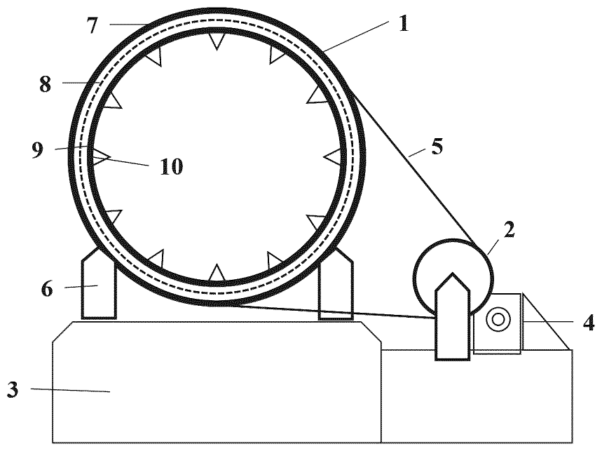

### CROSS-REFERENCE TO RELATED APPLICATIONS

This application claims priority to Chinese Patent Application No. 202510273621.5, filed on Mar. 10, 2025, the contents of which are hereby incorporated by reference.

### TECHNICAL FIELD

The present disclosure belongs to the technical field of building materials, and specifically relates to a method for fully utilizing old mortar on surfaces of recycled coarse aggregates.

### BACKGROUND

Crushing waste concrete into recycled coarse aggregates and applying them in new concrete structures yields good environmental and economic benefits. However, the surfaces of recycled coarse aggregates inevitably adhere to old cement mortar, resulting in poor bonding, high porosity, and strong water absorption in the interfacial transition zone between recycled coarse aggregates and new mortar, thereby significantly reducing the compressive strength and other properties of recycled concrete.

Currently, extensive research focuses on enhancing the performance of recycled coarse aggregates, including physical, chemical, and biological strengthening methods. The approaches for strengthening recycled coarse aggregates mainly fall into two categories: (1) using technical means to remove or reduce the old mortar on the surfaces of recycled coarse aggregates; and (2) improving the compactness of the interfacial transition zone between recycled coarse aggregates and old cement mortar, as well as enhancing the bonding force in the interfacial transition zone, through the filling of fine particles or chemical reactions. The first strengthening approach includes physical methods such as mechanical grinding, heat grinding, and particle shaping, as well as chemical methods such as acid washing. The second strengthening approach includes methods such as modification with mineral admixtures, carbonation strengthening, and microbial mineralization deposition. For example, Chinese Patent CN110436837A discloses a renewable concrete and its preparation method. The modification method for the modified recycled aggregates used therein includes the following steps: mechanical activation, acid treatment, filling treatment, and coating treatment. This disclosure removes the old mortar and edges from the surfaces of concrete particles through mechanical activation, dissolves the hardened cement paste on the surfaces of concrete particles in an acid solution through acid treatment to strengthen the interfacial transition zone of recycled concrete, then fills the gaps of the acidified concrete particles with nano fillers through filling treatment to enhance the structural strength of the aggregates, and finally encapsulates the recycled aggregates in a resin network to improve the bonding force between aggregates and enhance the compressive strength of the concrete.

Currently, there is considerable research on various methods for strengthening recycled coarse aggregates, each with different principles. However, most of these methods involve complex procedures, high costs, low returns, and poor cost-effectiveness, making it difficult to achieve widespread engineering application.

### SUMMARY

In view of the above shortcomings of the prior art, an objective of the present disclosure is to provide a method for fully utilizing old mortar on the surfaces of recycled coarse aggregates to improve the impact resistance of concrete. Instead of achieving large-scale application through strengthening recycled coarse aggregates, the present disclosure adopts a reverse approach by selecting recycled coarse aggregates of appropriate particle sizes and subjecting them to a weakening treatment. By utilizing the characteristics of the weak old mortar on the surfaces of recycled coarse aggregates, such as high brittleness, low elastic modulus, and low strength, the old mortar fractures first under blast or impact loads to absorb impact energy, thereby preserving the integrity of the main material and improving the blast resistance and impact resistance of the recycled concrete. This achieves high-value and large-scale application of recycled coarse aggregates.

To achieve the above objectives, the specific technical solutions of the present disclosure are as follows.

The disclosure provides a method for fully utilizing old mortar on surfaces of recycled coarse aggregates, including the following steps:
S1, performing a weakening treatment on the recycled coarse aggregates, with specific operations as follows: soaking the recycled coarse aggregates in a weak acid aqueous solution, and/or, placing the recycled coarse aggregates into a rotating drum with toothed rings on an inner surface for rotation, to obtain pre-treated recycled coarse aggregates; where an elastic modulus of old mortar on surfaces of the pre-treated recycled coarse aggregates is 15% to 80% of an elastic modulus of old mortar on surfaces of original recycled coarse aggregates;
S2, reacting an isocyanate component and an amino compound in solvent oil to obtain a polyurea coating material, then spraying the polyurea coating material onto the surfaces of the pre-treated recycled coarse aggregates to form a polyurea coating on the surfaces of the pre-treated recycled coarse aggregates, thereby obtaining modified recycled coarse aggregates; and
S3, preparing recycled concrete using the modified recycled coarse aggregates obtained in the step S2.

The present disclosure employs acid washing pretreatment on recycled coarse aggregates to reduce the compactness of the old mortar paste and lower the strength of the old mortar, ensuring its preferential fracture under high strain rate loads; and/or, by placing recycled coarse aggregates into a rotating drum with toothed rings on its inner surface and subjecting them to high-speed rolling, the recycled coarse aggregates collide with the toothed rings in the rotating drum, generating stress concentration that causes the old mortar paste to crack and form microcracks. During application, these microcracks in the old mortar paste rapidly propagate under high strain loads to dissipate impact energy. In summary, through the weakening treatment involving soaking in a weak acid aqueous solution and/or precracking in the rotating drum, the present disclosure ultimately achieves pre-treated recycled coarse aggregates whose surface old mortar has an elastic modulus of 15% to 80% of the elastic modulus of the surface old mortar of the original recycled coarse aggregates. This ensures that the old mortar on the surfaces of the modified recycled coarse aggregates fractures first under high strain loads to absorb impact energy and preserve the integrity of the main material. Finally, a polyurea coating is sprayed onto the surfaces of the weakened recycled coarse aggregates. Polyurea is a high-molecular-weight elastic polymer that exhibits excellent blast and impact resistance due to its ability to absorb and dissipate significant energy through the breaking of hydrogen bonds between its hard and soft segments under high strain rate loads. By spraying the polyurea coating on the surfaces of the recycled coarse aggregates, when the impact wave reaches the interface between the old mortar and the polyurea coating, the vast difference in impact resistance between the two causes the old mortar to fail to withstand the high strain rate load transmitted by the polyurea coating, thereby fracturing to absorb energy while preserving the integrity of the recycled coarse aggregates themselves, and improving the blast and impact resistance of the recycled concrete.

Optionally, in step S1, the old mortar content on the surfaces of the recycled coarse aggregates is 18 percent by weight to 30 percent by weight. When the old mortar content on the surfaces of the recycled coarse aggregates is too low, the impact energy dissipation is insufficient, allowing the shock wave to penetrate the old mortar layer and reach the coarse aggregate layer, thereby failing to achieve improved impact resistance. When the old mortar content on the surfaces of the recycled coarse aggregates is too high, cracks in the old mortar layer interconnect, forming through cracks in the recycled concrete, which compromises the integrity of the main material.

Optionally, the particle size of the recycled coarse aggregates is 25 to 40 millimeters. To ensure the residual amount of old mortar on the surfaces of the recycled coarse aggregates, the particle size of the recycled coarse aggregates may not be too small. Therefore, the present disclosure selects recycled coarse aggregates with a particle size of 25 to 40 millimeters.

Optionally, in step S1, the weak acid aqueous solution has a mass concentration of 0.3% to 1.0%, and the soaking time is 0.5 to 2 hours.

When the mass concentration of the weak acid aqueous solution and the soaking time are within the limits defined in the present disclosure, the compactness of the old mortar paste may be reduced while ensuring that the acid washing does not cause the old mortar to detach, thereby achieving pre-treated recycled coarse aggregates whose surface old mortar has an elastic modulus of 15% to 80% of the elastic modulus of the surface old mortar of the original recycled coarse aggregates.

Optionally, the weak acid aqueous solution has a pH value of 4.5 to 6.0.

Optionally, the weak acid aqueous solution is an aqueous solution of at least one of carbonic acid, nitrous acid, acetic acid, hypochlorous acid, and hydrofluoric acid.

Optionally, the recycled coarse aggregates are placed into a rotating drum with toothed rings on its inner surface and then rotated at 150 to 500 revolutions per minute for 20 to 40 minutes.

When the rotational speed and time of the rotating drum are within the limits defined in the present disclosure, the old mortar paste may be cracked to generate microcracks, resulting in pre-treated recycled coarse aggregates whose surface old mortar has an elastic modulus of 15% to 80% of the elastic modulus of the surface old mortar of the original recycled coarse aggregates.

Optionally, the rotating drum includes an inner rotating drum, a middle filter screen, and an outer drum shell, the toothed rings are arranged on the inner surface of the inner rotating drum and uniformly distributed along the circumferential direction of the inner rotating drum, and the cross-section of the toothed rings is triangular. When the rotating drum rotates, the recycled coarse aggregates collide with the tips of the toothed rings.

More optionally, the middle filter screen has an aperture of 15 to 20 millimeters. This ensures that dislodged fine old mortar particles are discharged while the recycled coarse aggregates remain retained inside the drum.

Optionally, no ultraviolet irradiation is allowed during the preparation processes of step S2 and step S3. The polyurea coating undergoes aging after ultraviolet irradiation, leading to reduced energy dissipation capacity.

Optionally, in step S3, the pouring of the recycled concrete is completed within 5 hours after spraying the polyurea coating material.

Optionally, the isocyanate component includes at least one of an aromatic isocyanate, an aliphatic isocyanate, and a polyisocyanate, the amino compound includes at least one of a diamine, a polyamine, and an amino-terminated polyether, and the solvent oil includes at least one of toluene, a naphthenic base oil, and Solvent Oil 150.

Optionally, the molar ratio of the isocyanate component to the amino compound is (1.2:1) to (0.95:1.05).

Optionally, the thickness of the polyurea coating is 3 to 5 millimeters.

Optionally, the preparation method of the polyurea coating material includes the following steps:
P1, weighing an isocyanate component, an amino compound, and solvent oil, placing them into a glass reaction kettle, raising the temperature to 90-105 degrees Celsius, removing water under vacuum, and reacting for 30-60 minutes;
P2, lowering the temperature in the reaction kettle to 60 degrees Celsius, adding water, and reacting for another 10-20 minutes to remove unreacted isocyanate component; and
P3, raising the temperature in the reaction kettle again to 90 degrees Celsius, adding an additive, performing vacuum defoaming, and stirring at 100-300 revolutions per minute for 1-5 minutes to obtain the polyurea coating material.

More optionally, the additive includes at least one of a defoamer, a catalyst, a dehydrating agent, a dispersant, and a curing agent.

Optionally, the recycled coarse aggregates are obtained by crushing waste concrete with a strength of 25 megapascals to 40 megapascals.

Optionally, the strength grade of the old mortar on the surfaces of the recycled coarse aggregates is M5 to M15, and the mud content of the recycled coarse aggregates is lower than 4 percent by weight.

Another objective of the present disclosure is to provide recycled concrete prepared by the method, including the following components in parts by weight: 750-920 parts of modified recycled coarse aggregates, 120-800 parts of fine aggregates, 150-225 parts of cement, 130-195 parts of fly ash, 140-310 parts of water, and 3-20 parts of an admixture.

A further objective of the present disclosure is to provide the use of the recycled concrete prepared by the method in blast-resistant and impact-resistant protective structures. Compared with the prior art, the advantages of the present disclosure are as follows.

The present disclosure no longer relies on strengthening recycled coarse aggregates to improve the performance of recycled concrete, but instead utilizes the weak point of recycled coarse aggregates (the old mortar) to actively fracture and sacrifice itself, thereby enhancing the blast and impact resistance of the recycled concrete.

Existing techniques for improving recycled concrete all achieve this by strengthening recycled coarse aggregates, which involves complex procedures and high costs, making it difficult to promote engineering applications. In contrast, the present disclosure directly utilizes the weak point of recycled coarse aggregates without requiring modification treatment, offering a simple technical path, ease of implementation, high cost-effectiveness, and enabling high-value utilization of bulk construction waste concrete.

By spraying a polyurea elastomer on the surfaces of recycled coarse aggregates, the present disclosure creates an energy dissipation difference at the interface between the old mortar and the polyurea coating. The old mortar may not withstand the high strain rate load transmitted by the polyurea coating, thus fracturing to absorb energy while preserving the integrity of the recycled coarse aggregates themselves. This method achieves directional fragmentation of microscopic materials through artificially created energy dissipation differences, giving the recycled concrete material significant designability.

The present disclosure may significantly enhance the blast and impact resistance of recycled concrete, providing it with broad application scenarios, enabling large-scale use of recycled concrete, and delivering notable ecological and economic benefits.

### BRIEF DESCRIPTION OF THE DRAWING

The FIGURE is a schematic diagram of the rotating drum used in the method of the present disclosure.

### DETAILED DESCRIPTION OF THE EMBODIMENTS

The technical solutions of the present disclosure will be clearly and completely described below. It is evident that the described embodiments are only a part of the embodiments of the present disclosure, and not all of them. All other embodiments obtained by a person of ordinary skill in the art based on the embodiments of the present disclosure without creative efforts shall fall within the protection scope of the present disclosure.

The method of the present disclosure for fully utilizing old mortar on the surfaces of recycled coarse aggregates to improve the impact resistance of concrete includes the following steps:
S1, performing a weakening treatment on the recycled coarse aggregates, with specific operations as follows: soaking the recycled coarse aggregates in a weak acid aqueous solution, and/or, placing the recycled coarse aggregates into a rotating drum with toothed rings on an inner surface for rotation, to obtain pre-treated recycled coarse aggregates; where an elastic modulus of old mortar on surfaces of the pre-treated recycled coarse aggregates is 15% to 80% of an elastic modulus of old mortar on surfaces of original recycled coarse aggregates;
S2, reacting an isocyanate component and an amino compound in solvent oil to obtain a polyurea coating material, then spraying the polyurea coating material onto the surfaces of the pre-treated recycled coarse aggregates to form a polyurea coating on the surfaces of the pre-treated recycled coarse aggregates, thereby obtaining modified recycled coarse aggregates; and
S3, preparing recycled concrete using the modified recycled coarse aggregates obtained in the step S2.

The old mortar content on the surfaces of the recycled coarse aggregates is 18 percent by weight to 30 percent by weight. For example, it may be 18%, 19%, 20%, 21%, 22%, 23%, 24%, 25%, 26%, 27%, 28%, 29%, or 30%.

The strength grade of the old mortar on the surfaces of the recycled coarse aggregates is M5 to M15, for example, it may be M5, M7.5, M10, or M15.

The mud content of the recycled coarse aggregates is lower than 4.0%, for example, it may be 1.0%, 1.5%, 2.0%, 2.5%, 3.0%, 3.5%, or 4.0%.

The weak acid aqueous solution is an aqueous solution of at least one of carbonic acid, nitrous acid, acetic acid, hypochlorous acid, and hydrofluoric acid.

The molar ratio of the isocyanate component to the amino compound is (1.2:1) to (0.95:1.05).

The isocyanate component includes at least one of an aromatic isocyanate, an aliphatic isocyanate, and a polyisocyanate, the amino compound includes at least one of a diamine, a polyamine, and an amino-terminated polyether, and the solvent oil includes at least one of toluene, a naphthenic base oil, and Solvent Oil 150.

In the following embodiments and comparative examples, the original compressive strength of the waste concrete is 26.9 megapascals (obtained through actual measurement), and the old mortar content on the surfaces of the recycled coarse aggregates is 18 percent by weight to 30 percent by weight. The fine aggregates are natural river sand with a particle size of 0-5 millimeters and a fineness modulus of 2.4. The cement is Huaxin 42.5 ordinary Portland cement. The fly ash is Grade I fly ash produced by Yangluo Power Plant in Wuhan. The admixture is a polycarboxylate superplasticizer with a water reduction rate of 22-28%.

As shown in the FIGURE, the self-made rotating drum used in the following embodiments and comparative examples includes a rotating drum 1, which is mounted on a base 3 via supports 6. A drive gear 2 and a motor 4 are also provided on the base 3. A track 5 is connected between the rotating drum 1 and the drive gear 2. The motor 4 drives the drive gear 2 to rotate, and the drive gear 2 then drives the rotating drum 1 to perform high-speed rolling via the track 5. The rotating drum 1 consists of three parts: an inner rotating drum 9, a middle filter screen 8, and an outer drum shell 7. Toothed rings 10 are arranged every 30 degrees along the inner circumference of the inner rotating drum 9, and the toothed rings 10 are arranged every 20 millimeters along the axial direction of the inner rotating drum 9. The aperture of the middle filter screen is 15 millimeters to 20 millimeters. When the motor 4 is started, the rotating drum 1 is driven to rotate circumferentially, causing the recycled coarse aggregates inside to roll. The recycled coarse aggregates collide with the toothed rings 10 inside the rotating drum 1, generating stress concentration that causes the old mortar paste to crack and form microcracks.

### Embodiment 1

This embodiment provides a method for fully utilizing old mortar on surfaces of recycled coarse aggregates, including the following steps:
S1, waste concrete is broken by a pneumatic hammer into concrete blocks with dimensions of approximately 100 millimeters×100 millimeters×100 millimeters, then the blocks are fed into the feed port of a jaw crusher, after mechanical crushing, recycled coarse aggregates with a particle size of 25-40 millimeters are selected for later use;
S2, the recycled coarse aggregates obtained in step S1 are soaked in a hypochlorous acid solution for 1.5 hours, the mass fraction of hypochlorous acid in the hypochlorous acid solution is 0.45%, and the pH value is 5.2, after soaking, the aggregates are taken out, washed with water, and drained for later use;
S3, the recycled coarse aggregates obtained in step S2 are placed into a self-made rotating drum, the rotating drum is operated at a speed of 150 revolutions per minute for 20 minutes, to obtain pre-treated recycled coarse aggregates; the elastic modulus of the old mortar on the surfaces of the obtained pre-treated recycled coarse aggregates is 50.9% of the elastic modulus of the old mortar on the surfaces of the original recycled coarse aggregates;
S4, 100 grams of isophorone diisocyanate (IPDI) (90% mass fraction), 89 grams of polyoxypropylene diamine (98% mass fraction, average molecular weight 230), and 20 grams of xylene are placed into a glass reaction kettle, the temperature is raised to 95±5 degrees Celsius, water is removed under vacuum, and the reaction is carried out for 30 minutes; then the temperature in the reaction kettle is lowered to 60 degrees Celsius, 20 milliliters of water is added, and the reaction is continued for 15 minutes to remove unreacted isocyanate; then the temperature in the reaction kettle is raised again to 90 degrees Celsius, a silicone defoamer TEGO (0.1% mass fraction) and an organic bismuth catalyst E20 are added, vacuum defoaming is performed, and stirring is conducted for 1 minute at a speed of 200 revolutions per minute, to obtain a polyurea coating material; then the obtained polyurea coating material is sprayed onto the surfaces of the recycled coarse aggregates using an air gun to form a polyurea coating with a thickness of 3 millimeters, thus obtaining modified recycled coarse aggregates;
S5, the modified recycled coarse aggregates obtained in step S4 are used to prepare recycled concrete, the prepared recycled concrete includes the following components in parts by weight: 810 parts of modified recycled coarse aggregates, 370 parts of fine aggregates, 185 parts of cement, 160 parts of fly ash, 245 parts of water, and 12 parts of admixture; and
S6, the recycled concrete prepared in step S5 is cast into cylindrical specimens with dimensions of @100 millimeters×50 millimeters, the specimens are cured in a standard curing room for 28 days, and then a single-impact dynamic compression test is performed, the specific test process is as follows: both end surfaces of the specimens are ground to high precision with an angle grinder until the average flatness of the loading surfaces is less than 0.03 millimeters, a SHPB test apparatus is used to conduct single-impact dynamic compression tests on the recycled concrete specimens, friction-reducing sheets are attached to the loading surfaces at both ends of the specimens, the impact air pressure of the launcher is set at seven levels: 0.1 megapascals, 0.2 megapascals, 0.3 megapascals, 0.4 megapascals, 0.5 megapascals, 0.6 megapascals, and 0.7 megapascals, and each test group includes three cylindrical specimens.

All preparation processes in this embodiment are performed without ultraviolet irradiation, and the pouring of the recycled concrete is completed within 2 hours after the spraying of the polyurea coating material.

### Embodiment 2

The method of this embodiment is basically the same as that of Embodiment 1, with the difference that in step S4, the thickness of the polyurea coating is 4 millimeters.

### Embodiment 3

The method of this embodiment is basically the same as that of Embodiment 1, with the difference that in step S4, the thickness of the polyurea coating is 5 millimeters.

### Embodiment 4

The method of this embodiment is basically the same as that of Embodiment 1, with the difference that step S2 is omitted in this embodiment, and the elastic modulus of the old mortar on the surfaces of the obtained pre-treated recycled coarse aggregates is 77.6% of the elastic modulus of the old mortar on the surfaces of the original recycled coarse aggregates.

### Embodiment 5

The method of this embodiment is basically the same as that of Embodiment 1, with the difference that step S3 is omitted in this embodiment, and the elastic modulus of the old mortar on the surfaces of the obtained pre-treated recycled coarse aggregates is 69.8% of the elastic modulus of the old mortar on the surfaces of the original recycled coarse aggregates.

### Embodiment 6

The method of this embodiment is basically the same as that of Embodiment 1, with the differences that step S2 is as follows: the recycled coarse aggregates obtained in step S1 are soaked in a hypochlorous acid solution for 0.5 hours, the mass fraction of hypochlorous acid in the hypochlorous acid solution is 1.0%, and the pH value is 4.7, after soaking, the aggregates are taken out, washed with water, and drained for later use; and step S3 is as follows: the recycled coarse aggregates obtained in step S2 are placed into a self-made rotating drum, the rotating drum is operated at a speed of 500 revolutions per minute for 40 minutes, and the elastic modulus of the old mortar on the surfaces of the obtained pre-treated recycled coarse aggregates is 20.3% of the elastic modulus of the old mortar on the surfaces of the original recycled coarse aggregates.

### Comparative Example 1

The method of this comparative example is basically the same as that of Embodiment 1, with the difference that steps S2 to S4 are omitted; and that is, this comparative example directly uses the recycled coarse aggregates with a particle size of 25-40 millimeters obtained in step S1 to prepare recycled concrete.

### Comparative Example 2

The method of this comparative example is basically the same as that of Embodiment 1, with the difference that the modified recycled coarse aggregates obtained in step S4 are irradiated under ultraviolet light for 4 hours before the pouring of the recycled concrete.

### Comparative Example 3

The method of this comparative example is basically the same as that of Embodiment 1, with the difference that in step S2, the mass fraction of hypochlorous acid in the hypochlorous acid solution is 1.5%, the pH value is 3.2, and the soaking time is 4 hours; and the elastic modulus of the old mortar on the surfaces of the obtained pre-treated recycled coarse aggregates is 9.06% of the elastic modulus of the old mortar on the surfaces of the original recycled coarse aggregates.

### Comparative Example 4

The method of this comparative example is basically the same as that of Embodiment 1, with the difference that in step S3, the self-made rotating drum is operated at a speed of 500 revolutions per minute for 60 minutes, and the elastic modulus of the old mortar on the surfaces of the obtained pre-treated recycled coarse aggregates is 11.2% of the elastic modulus of the old mortar on the surfaces of the original recycled coarse aggregates.

### Comparative Example 5

The method of this comparative example is basically the same as that of Embodiment 1, with the difference that steps S2 and S3 are omitted, and no pre-treatment is performed on the recycled coarse aggregates.

### Comparative Example 6

The method of this comparative example is basically the same as that of Embodiment 1, with the difference that in step S1, recycled coarse aggregates with a particle size of 16-31 millimeters are selected for later use.

The dynamic stress-strain curves of the recycled concrete specimens from Embodiments 1-6 and Comparative Examples 1-6 are organized and analyzed, and the load strain rate \dot{ε} is calculated following the method below.

The input load is Fᵢ(t)=EA₀[εᵢ(t)−εᵣ(t)].

The output load is Fₜ(t)=EA₀εₜ(t).

The average stress of the specimen is

$$σ ( t ) = \frac{{F}_{i} ( t ) - {F}_{t} ( t )}{2 {A}_{s}} - \frac{{A}_{0}}{2 {A}_{s}} [ E ( {ε}_{i} ( t ) - {ε}_{r} ( t ) - {ε}_{t} ( t ) ] .$$

The displacement at both ends of the specimen is

$${d}_{i} ( t ) = {C}_{0} {\int }_{0}^{t} [ {ε}_{i} ( t ) \to {ε}_{r} ( t ) ] dt ;$$

$${d}_{t} ( t ) = {C}_{0} {\int }_{0}^{t} {ε}_{t} ( t ) dt .$$

The average strain of the specimen is

$$ε ( t ) = \frac{{d}_{i} ( t ) - {d}_{t} ( t )}{{L}_{s}} = \frac{{C}_{0}}{{L}_{s}} {\int }_{0}^{t} [ {ε}_{i} ( t ) - {ε}_{r} ( t ) - {ε}_{t} ( t ) ] dt .$$

The average strain rate is

$$\dot{ε} ( t ) = \frac{{C}_{0}}{{L}_{s}} [ {ε}_{i} ( t ) - {ε}_{r} ( t ) - {ε}_{t} ( t ) ] .$$

Based on the uniformity assumption: εₜ(t)=εᵢ(t)+εᵣ(t).

The average strain rate of the specimen is calculated as

$$\dot{ε} ( t ) = - 2 \frac{{C}_{0}}{{L}_{s}} {ε}_{r} ( t ) .$$

In the above formulas, E, A₀, and C₀ represent the elastic modulus, cross-sectional area, and stress pulse velocity of the SHPB apparatus bars, respectively. A_{S} and L_{S} represent the cross-sectional area and thickness of the specimen. εᵢ (t), εᵣ (t), and εₜ (t) represent the incident wave, reflected wave, and transmitted wave strain signals of the test, respectively. The test results are shown in Table 1.

TABLE 1
Dynamic Compression Mechanical Performance
Indicators of Recycled Concrete Specimens

| | Impact air | | Dynamic peak |
|---|---|---|---|
| | pressure | \acute{ε}(t) | stress σₚ |
| Embodiments | (megapascals) | (s⁻¹) | (megapascals) |
| Embodiment 1 | 0.1 | 112.33 ± 3.12 | 29.96 ± 0.31 |
| | 0.2 | 158.45 ± 6.24 | 40.28 ± 0.55 |
| | 0.3 | 239.15 ± 2.01 | 67.44 ± 0.74 |
| | 0.4 | 267.29 ± 4.42 | 92.32 ± 1.21 |
| | 0.5 | 308.36 ± 8.16 | 122.09 ± 0.46 |
| | 0.6 | 366.89 ± 5.18 | 137.29 ± 0.29 |
| | 0.7 | 452.13 ± 3.65 | 158.42 ± 0.87 |
| Embodiment 2 | 0.4 | 258.29 ± 5.22 | 103.32 ± 2.02 |
| | 0.5 | 311.36 ± 5.63 | 189.11 ± 1.78 |
| | 0.6 | 403.01 ± 4.63 | 217.38 ± 0.23 |
| Embodiment 3 | 0.5 | 340.30 ± 2.34 | 249.13 ± 0.64 |
| Embodiment 4 | 0.5 | 346.21 ± 3.67 | 103.43 ± 1.24 |
| Embodiment 5 | 0.5 | 331.69 ± 5.31 | 100.51 ± 2.22 |
| Embodiment 6 | 0.5 | 319.54 ± 3.33 | 116.77 ± 0.19 |
| Comparative | 0.5 | 346.09 ± 6.01 | 50.19 ± 1.94 |
| Example 1 | | | |
| Comparative | 0.5 | 300.37 ± 3.36 | 89.18 ± 0.56 |
| Example 2 | | | |
| Comparative | 0.5 | 325.11 ± 3.69 | 62.33 ± 0.67 |
| Example 3 | | | |
| Comparative | 0.5 | 328.73 ± 4.36 | 70.01 ± 2.13 |
| Example 4 | | | |
| Comparative | 0.5 | 319.33 ± 3.18 | 79.86 ± 0.53 |
| Example 5 | | | |
| Comparative | 0.5 | 329.36 ± 6.97 | 101.77 ± 0.19 |
| Example 6 | | | |

From the test results in Table 1, it may be seen that the recycled concrete specimens obtained by the method of the present disclosure exhibit a dynamic compression peak stress of 100.51-249.13 megapascals under an impact air pressure of 0.5 megapascals, which represents an increase of 100.25%-396.37% compared to the recycled concrete specimens of Comparative Example 1 (dynamic compression peak stress of 50.19 megapascals), demonstrating the effectiveness of the method of the present disclosure.

Comparing Embodiments 1-3, it is observed that as the thickness of the polyurea coating increases, the impact resistance of the prepared recycled concrete significantly improves, allowing for the design of the polyurea coating thickness based on the expected material performance targets.

By comparing Embodiment 1 with Embodiments 4-5, it is found that when the weakening treatment is applied solely through weak acid soaking or rotating drum pre-cracking, the impact resistance of the recycled concrete specimens is somewhat reduced.

Compared with Embodiment 1, the modified recycled coarse aggregates in Comparative Example 2 are irradiated with ultraviolet light, which causes aging of the polyurea coating and reduces its energy dissipation capacity, resulting in a decrease in the dynamic compression peak stress under an impact air pressure of 0.5 megapascals from 122.09 megapascals to 89.18 megapascals.

Compared with Embodiment 1, Comparative Example 3 involves soaking the recycled coarse aggregates in a strong acid solution, and Comparative Example 4 involves prolonged high-speed operation of the rotating drum, both of which cause the old mortar on the surfaces of the recycled coarse aggregates to peel off, significantly reducing the residual mortar content. As a result, there is insufficient old mortar to resist the impact wave under impact loading, leading to reduced impact resistance of the recycled concrete.

Compared with Embodiment 1, Comparative Example 5 uses recycled coarse aggregates whose surface old mortar has not undergone weakening treatment, resulting in a reduced energy dissipation difference at the old mortar-polyurea coating interface and a significant decrease in the impact resistance of the recycled concrete specimens.

Compared with Embodiment 1, Comparative Example 6 uses recycled coarse aggregates with excessively small particle sizes, resulting in low residual old mortar content on their surfaces. Under impact loading, there is insufficient old mortar to resist the impact wave, leading to reduced impact resistance of the recycled concrete.

In summary, the method of the present disclosure for improving the impact resistance of recycled concrete by utilizing the old mortar on the surfaces of recycled coarse aggregates involves first weakening the recycled coarse aggregates through soaking in a weak acid aqueous solution and/or pre-cracking in a rotating drum, and then spraying a polyurea elastomer on the surfaces of the recycled coarse aggregates to artificially create an energy dissipation difference at the interface between the old mortar and the polyurea coating. Under high-speed impact waves, the weak point of the recycled coarse aggregates (the old mortar) actively fractures and sacrifices itself to absorb and dissipate energy, achieving a significant improvement in the impact resistance of the recycled concrete.

Although the embodiments of the present disclosure have been shown and described, it may be understood by those of ordinary skill in the art that various changes, modifications, substitutions, and variations may be made to these embodiments without departing from the principles and spirit of the present disclosure, and the scope of the present disclosure is defined by the appended claims and their equivalents.

What is claimed is:

1. A method for fully utilizing old mortar on surfaces of recycled coarse aggregates to improve impact resistance of concrete, comprising the following steps:
S1, performing a weakening treatment on the recycled coarse aggregates, with specific operations as follows: soaking the recycled coarse aggregates in a weak acid aqueous solution, and/or, placing the recycled coarse aggregates into a rotating drum with toothed rings on an inner surface for rotation, to obtain pre-treated recycled coarse aggregates; wherein an elastic modulus of old mortar on surfaces of the pre-treated recycled coarse aggregates is 15% to 80% of an elastic modulus of old mortar on surfaces of original recycled coarse aggregates;
S2, reacting an isocyanate component and an amino compound in solvent oil to obtain a polyurea coating material, then spraying the polyurea coating material onto the surfaces of the pre-treated recycled coarse aggregates to form a polyurea coating on the surfaces of the pre-treated recycled coarse aggregates, thereby obtaining modified recycled coarse aggregates; and
S3, preparing recycled concrete using the modified recycled coarse aggregates obtained in the step S2.

2. The method according to claim 1, wherein in the step S1, an old mortar content on surfaces of the recycled coarse aggregates is 18 percent by weight to 30 percent by weight.

3. The method according to claim 1, wherein in the step S1, the weak acid aqueous solution has a mass concentration of 0.3% to 1.0%, with a soaking time of 0.5 to 2 hours.

4. The method according to claim 1, wherein the recycled coarse aggregates are placed into the rotating drum with the toothed rings on the inner surface, and then rotated at 150 to 500 revolutions per minute for 20 to 40 minutes.

5. The method according to claim 1, wherein the rotating drum comprises an inner rotating drum, a middle filter screen, and an outer drum shell, wherein the toothed rings are arranged on an inner surface of the inner rotating drum and uniformly distributed along a circumferential direction of the inner rotating drum, and a cross-section of the toothed rings is triangular.

6. The method according to claim 1, wherein no ultraviolet irradiation is allowed during preparation processes of the step S2 and the step S3.

7. The method according to claim 1, wherein in the step S3, pouring of the recycled concrete is completed within 5 hours after spraying the polyurea coating material.

8. The method according to claim 1, wherein the isocyanate component comprises at least one of an aromatic isocyanate, an aliphatic isocyanate, or a polyisocyanate, the amino compound comprises at least one of a polyamine or an amino-terminated polyether, and the solvent oil comprises at least one of toluene, a naphthenic base oil, or Solvent Oil 150.

9. The recycled concrete prepared by the method according to claim 1, comprising the following components in parts by weight: 750-920 parts of the modified recycled coarse aggregates, 120-800 parts of fine aggregates, 150-225 parts of cement, 130-195 parts of fly ash, 140-310 parts of water, and 3-20 parts of an admixture.
